(19) United States
(12) Patent Application Publication
(10) Pub. No.: US 2013/0108977 A1
(43) Pub. Date: May 2, 2013

(54) ORTHODONTIC APPLIANCES WITH A CURVE

(71) Applicants: Hong-Bum SHON, Chuncheon-si (KR); Youn-Sang HWANG, Chuncheon-si (KR); In-Sun SON, Chuncheon-si (KR)

(72) Inventors: Hong-Bum SHON, Chuncheon-si (KR); Youn-Sang HWANG, Chuncheon-si (KR); In-Sun SON, Chuncheon-si (KR)

(21) Appl. No.: 13/312,419

(22) Filed: Dec. 6, 2011

(30) Foreign Application Priority Data
Oct. 31, 2011 (KR) 10-2011-0111844

(51) Int. Cl. A61C 7/16

(52) U.S. Cl. 433/9

(57) ABSTRACT

An orthodontic appliance comprises a bracket bonded on the surface of the tooth, which includes an insertion groove whose bottom surface is round for use of an improved orthodontic wire and a pair of wings, and an orthodontic wire inserted into the insertion groove of the bracket, that is round to allow two orthodontic wire surfaces to be closely combined onto the bottom surface of the insertion groove.

### CROSS REFERENCES

Applicant claims foreign priority under Paris Convention to Korean Patent Application No. 10-2011-0111844 filed Oct. 31, 2011, with the Korean Intellectual Property Office, where the entire contents are incorporated herein by reference.

### BACKGROUND OF THE INVENTION

1. Field of the Invention

The present invention relates to an orthodontic appliance with a curve that corrects and arranges teeth, and more particularly, to an orthodontic appliance with a curve that can improve a fixed state of an insertion groove of an orthodontic bracket an orthodontic wire inserted to the insertion groove.

2. Description of the Prior Art

Generally, “malocclusion” means a state that a tooth of a person is crooked and a set of the teeth is irregular. A treatment for the malocclusion is referred to as orthodontic treatment.

Until now, various kinds of orthodontic appliances have been developed and used for corrective treatment. In addition, they usually consist of several parts such as brackets, orthodontic wires and binders.

For orthodontic treatment, a bracket bonded onto misaligned teeth is formed integrally with wings that connect a binder, and an insertion groove is vertically positioned on the wings to allow insertion of an orthodontic wire for fixing and arranging the bracket, which is formed round or rectangular. Likewise, a structural problem of edges formed between the orthodontic wire and the groove cause inconvenience in allowing the orthodontic wire to be inserted into and removed from the insertion groove of the bracket. Accordingly, due to difficulties in controlling movement or positioning of the bracket, orthodontic treatment can be unsuccessful, which leads to lower efficiency and longer duration of orthodontic treatment.

Therefore, orthodontic appliances with new structural connection between an orthodontic wire and a bracket are required to achieve convenience and accuracy of orthodontic treatment, as well as shorter duration of the treatment.

### SUMMARY OF THE INVENTION

Accordingly, an object of the present invention is to provide a plane arch wire appliance that can achieve convenience and accuracy of orthodontic treatment, as well as shorter duration of the treatment, by improving structural connection between the conventional bracket and an orthodontic wire.

Additional advantages, objects and features of the invention will be set forth in part in the description which follows and in part will become apparent to those having ordinary skill in the art upon examination of the following or may be learned from practice of the invention.

According to an aspect of the present invention, there can be provided an orthodontic appliance, which includes a bracket with an attachment plate attached on the surface of a tooth, wherein an insertion groove for the orthodontic wire is formed vertical and its bottom surface is formed curved, and the orthodontic wire whose both sides are curved formed to be firmly fitted and inserted to the insertion groove.

### BRIEF DESCRIPTION OF THE DRAWINGS

The above and other objects, features and advantages of the present invention will be more apparent from the following detailed description taken in conjunction with the accompanying drawing, in which:

FIG. 1 is a perspective view illustrating parts which are used for orthodontic treatment according to the present invention;

FIG. 2 is a cross-sectional view illustrating a bracket among the parts according to the present invention;

FIG. 3 is a cross-sectional view illustrating an orthodontic wire among the parts according to the present invention; and

FIG. 4 is an exemplary view illustrating coupling between the bracket and the orthodontic wire according to the present invention.

### DETAILED DESCRIPTION OF THE INVENTION

Hereinafter, preferred embodiments of the present invention will be described in detail with reference to the accompanying drawing. The aspects and features of the present invention and methods for achieving the aspects and features will be apparent by referring to the embodiments to be described in detail with reference to the accompanying drawings. However, the present invention is not limited to the embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims. In the entire description of the present invention, the same drawing reference numerals are used for the same elements across various figures.

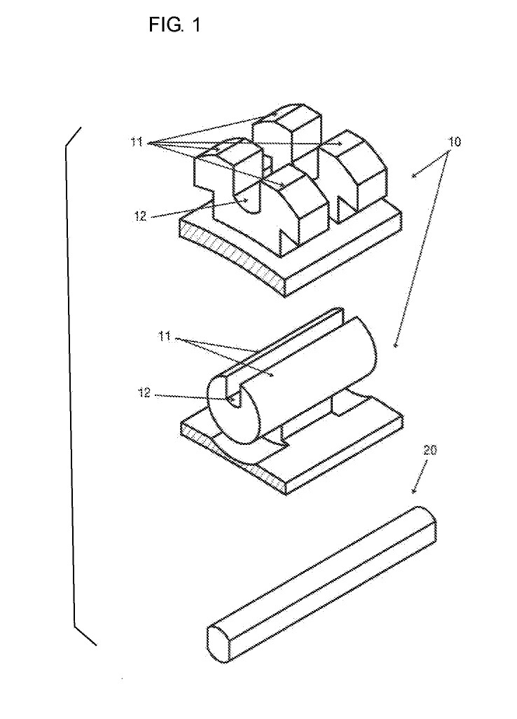

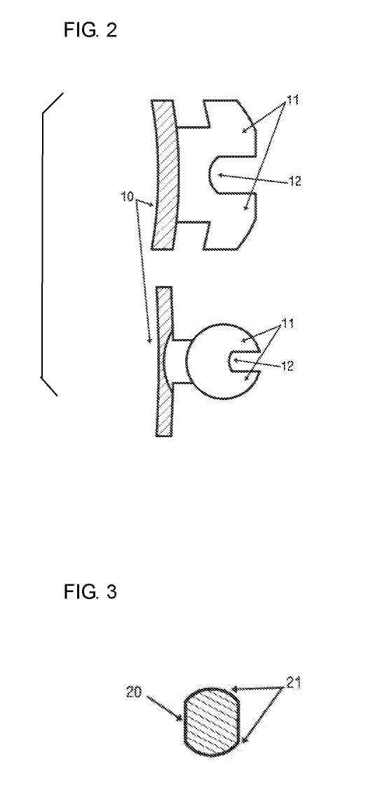

FIG. 1 is a perspective view illustrating parts of an orthodontic appliance according to the present invention, and FIG. 2 is a cross-sectional view illustrating a bracket according to the present invention.

With reference to FIG. 2, a bracket 10 bonded on the tooth is integrally formed with a pair of wings 11 on a plate-shape base. The bottom surface of an insertion groove 12 that is formed between the wings 11is curved, different from being horizontally plane in the conventional appliance.

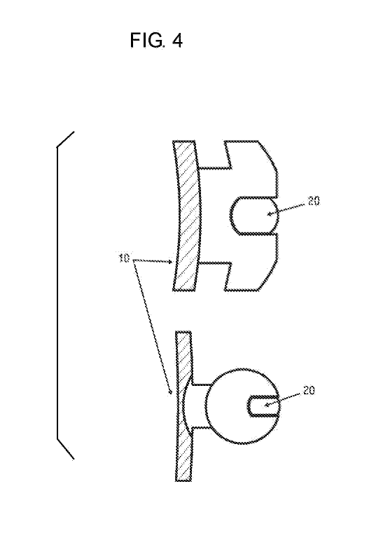

In addition, with reference to FIG. 3, an orthodontic wire 20 that is combined with the insertion groove 12 formed between the wings 11 of the bracket 10 to support the bracket 10, allows two orthodontic wire surfaces 21 to be round and other surfaces to be vertical or horizontal, unlike the conventional orthodontic wire that is round or rectangular.

FIG. 4 is an exemplary view illustrating coupling between an orthodontic wire and a bracket among parts according to the present invention.

With reference to FIG. 4, two orthodontic wire surfaces 21 of the orthodontic wire 20 are closely fitted onto the bottom surface of the insertion groove 12 of the bracket 10 to allow easier insertion and removal when the orthodontic wire 20 is slidingly inserted into the insertion groove 12 of the bracket 10.

As described above, the natural circulation boiler for heating according to the present invention produce the following effects.

First, it can promote the convenience of orthodontic treatment by achieving a greater reduction of frictional force between a bracket and an orthodontic wire, in comparison with the conventional rectangular structure, according as the bottom surface of the insertion groove of the bracket is closely fitted to two round orthodontic wire surfaces of the orthodontic wire, resulting in easier insertion and removal when the orthodontic wire is slidingly inserted into the insertion groove of the bracket.

Second, it can achieve higher accuracy and shorter duration of orthodontic treatment by accurately controlling movement of the bracket according to reduced frictional force to arrange teeth in the right position.

It should be understood by those of ordinary skill in the art that various replacements, modifications and changes in the form and details may be made therein without departing from the spirit and scope of the present invention as defined by the following claims. Therefore, it is to be appreciated that the above described embodiments are for purposes of illustration only and are not to be construed as limitations of the invention.

What is claimed is:

1. An orthodontic appliance, comprising:
a bracket bonded on the surface of the tooth, which includes an insertion groove whose bottom surface is round for use of an improved orthodontic wire and a pair of wings; and
an orthodontic wire inserted into the insertion groove of the bracket, that is round to allow two orthodontic wire surfaces to be closely combined onto the bottom surface of the insertion groove.

2. The orthodontic appliance of claim 1, wherein the insertion groove whose bottom surface is round is formed between the wings of the bracket to be closely combined with the orthodontic wire.

3. The orthodontic appliance of claim 1, wherein the orthodontic wire is combined with the insertion groove and the two orthodontic wire surfaces alone are round.
